(19) United States
(12) Patent Application Publication
(10) Pub. No.: US 2023/0395058 A1
(43) Pub. Date: Dec. 7, 2023

(54) DEVICE FOR AUDIO SIGNAL CONTROL THROUGH EFFECTS UNITS

(71) Applicant: Daniel Torres Villanueva, Leon (MX)

(72) Inventor: Daniel Torres Villanueva, Leon (MX)

(21) Appl. No.: 18/044,975

(22) PCT Filed: Sep. 2, 2021
(86) PCT No.: PCT/MX2021/050049

§ 371 Date: Mar. 10, 2023

(30) Foreign Application Priority Data
Sep. 11, 2020 (MX) MX/U/2020/000411

(51) Int. Cl. G10K 11/34; G10K 11/178

(52) U.S. Cl. CPC G10K 11/341; G10K 11/1787

(57) ABSTRACT

Electronic device that allows controlling the route followed by an audio signal from one or more Audio Signal Input Sources through 2 or more Effects Units which modify said signal, and said signal is delivered to 1 or more Outputs, which allows selecting from which input the audio signal is originated, through which effects units is passed, in what order it does so, and to which outputs it is delivered, through a matrix of high-speed signal switching devices (analog or digital) with features of an audio signal that interconnects all possible combinations of Inputs and Outputs between ports to which Audio Signal Input Sources, External Effects Units and Outputs are connected, which is controlled by a digital device that allows the activation of the possible combinations at the User's choice; It further allows storing the desired combinations in a memory unit to be later retrieved and activated, through various embodiments of use such as the direct manipulation of the Device with physical controls, through an application within external wireless devices and/or compatible with MIDI.

### TECHNICAL FIELD

The present invention is related to the audio industry. Particularly, it refers to an electronic device making possible to control the route followed by an audio signal through various devices which modify said signal. Specifically, it refers to a device allowing to choose whether or not an audio signal passes through an external device, and also in what order it does so. The combinations of devices through which the audio signal passes and the order in which it does so, hereinafter “Route”, is stored in a memory module, which allows the retrieval of stored Routes.

### BACKGROUND OF THE INVENTION

In the field of audio signal control there are several options on the market, however, they are limited to controlling the route in terms of whether or not the signal passes through a certain external device which modifies the original signal, hereinafter “Effects Unit”, and do not allow the choice of the order in which it passes therethrough. When an audio signal passes through several Effects Units, the order in which it does so directly affects the final result of the signal, which means a disadvantage of the existing options by not allowing control of the order.

In the field of audio signal control there are the documents GB2405987A, U.S. Pat. Nos. 5,475,214A, 4,030,397A, 4,509,190A, 4,481,661A, JP2017173134A, P662911162, U.S. Pat. No. 5,642,425A, EP1732233A1, JP2017049307A, JP655501462, JP2009105612A, KR10132728661, FR2645387A1 and FR2645387B1 which describe various devices. The most related to the invention are described below.

The document GB2405987A describes a musical effects control device which is addressed to guitarists, which consists of a device that is placed on the floor and to which up to 10 external effects units are connected, and it is controlled whether or not it possible to pass through a determined effects unit. Although this device allows to control the route of the audio signal, it does not allow to choose the order in which it will pass through the external devices, in addition to the fact that the application is limited to guitarists, when the need to control the route that an audio signal follows through external units is relevant for different applications both in a variety of instruments and signal conditioning processes live or in the studio. Additionally, the described device is limited with respect to the number of external effects that can be controlled by the same.

Document U.S. Pat. No. 4,030,397A describes a device that allows controlling the pass of a musical instrument signal through several effects units implemented therein, and choosing whether or not to pass through a particular one, however, it is only limited to the internal effects units and does not allow the inclusion of external effects units.

Documents U.S. Pat. Nos. 4,509,190A and 4,481,661A describe a device that allows controlling the passage of the musical instrument signal through several effect units implemented in the form of interchangeable cartridges, however, it contains the limitation of being compatible only with the effects units that have this form factor and to control the order of these it is required physical removal and insertion.

Document U.S. Pat. No. 5,642,425A describes a device that routes the audio signal from various sources through an acoustic chamber and back to the source to generate a feedback of the signal to generate a specific effect, which represents a disadvantage by only controlling one specific effect and not be compatible with external effects units.

Due to the above, the need for the development of a device which controls the route of an audio signal from 1 or more inputs through 2 or more effects units up to 1 or more outputs is evident, being able to define from which input the signal is originated, through which Effect Units it passes, in which order it does so and to which outputs it is delivered; In addition to the possibility of being used in a greater variety of instruments or processes related to audio, either live or in the studio, as well as flexibility in the number of effect units involved in the audio signal route.

### OBJECTS OF THE INVENTION

It is therefore an object of this invention to provide an electronic device that allows controlling the route that an audio signal follows from 1 or more inputs through 2 or more Effect Units that modify said signal to 1 or more outputs.

An additional object is to provide an electronic device that allows to controlling the route that an audio signal follows, which allows choossing from which input the audio signal is originated, through which effect units is passed, in which order it does so, and to which outputs it is delivered.

Another object of the invention is to provide an electronic device that allows controlling the route that an audio signal follows that can include a preamplifier in the input connection of each Effects Unit.

Another object of the invention is to provide an electronic device that allows controlling the route followed by an audio signal which can store in a memory module the combinations of inputs, devices through which the audio signal passes and the order in which it does so, which allows them to be recovered and activated in a time period of up to 200 ms.

It is also another object of the invention to offer various control and operation embodiments of the device.

### BRIEF DESCRIPTION OF THE INVENTION

These and other objects are achieved by means of an electronic device that allows controlling the route followed by an audio signal from 1 or more Audio Signal Input Sources through 2 or more Effect Units which modify said signal and wherein said signal is delivered up to 1 or more Outputs, which allows choossing from which input the audio signal is originated, through which effects units is passed, in what order it does so and to which outputs is delivered; said device is conformed by: an Interconnection Section comprising mainly physical interfaces and a matrix of high-speed signal switching devices (analog or digital) with the features of an audio signal that allows the interconnection of the whole Inputs with the whole Outputs; a Control Section which allows activating one or more of the possible interconnection combinations, called Routes, and storing these combinations in a memory module; and a User Interface Section through which the User chooses which Route is activated.

### DESCRIPTION OF THE FIGURES

FIG. 1 is a block diagram showing the main elements included in the device.

FIG. 2 is a representation of the interconnections made in the matrix of signal switching devices.

FIG. 3 shows the structure of the Digital Logic Matrix for the control of the signal switching devices matrix, showing the invalid states that do not depend on a specific route.

FIG. 4 shows the status of an example of Digital Logic Matrix to control signal switching devices for a determined route in an exemplary device with 2 Audio signal Input Sources, 4 Effects Units and 2 Outputs, wherein a single audio signal is controlled that enters through Input 1, passing firstly through Unit 3, then through Unit 1, then through Unit 2 and is delivered to the output, where the whole invalid states for that route are shown.

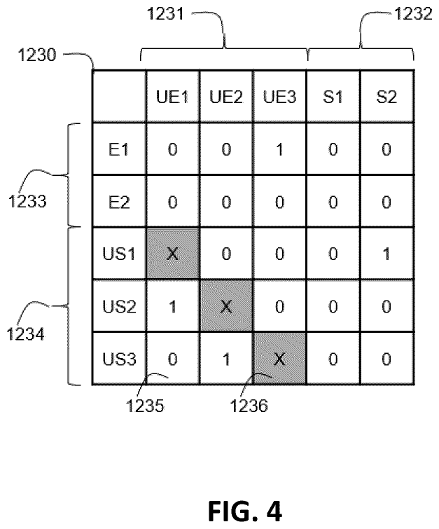

FIG. 5 is a representation of the interconnections performed in the signal switching device matrix in an exemplary device with 2 Audio Signal Input Sources, 4 Effects Units and 2 Outputs, where a single audio signal is controlled that enters through input 1, passing firstly through Unit 3, then through Unit 1, then through Unit 2 and is delivered to the output 2.

FIG. 6 is an example of the implementation of the Device for controlling the signal of two musical instruments through 8 Effects Units and operated through an Application and a MIDI external Control Device.

### DETAILED DESCRIPTION OF THE INVENTION

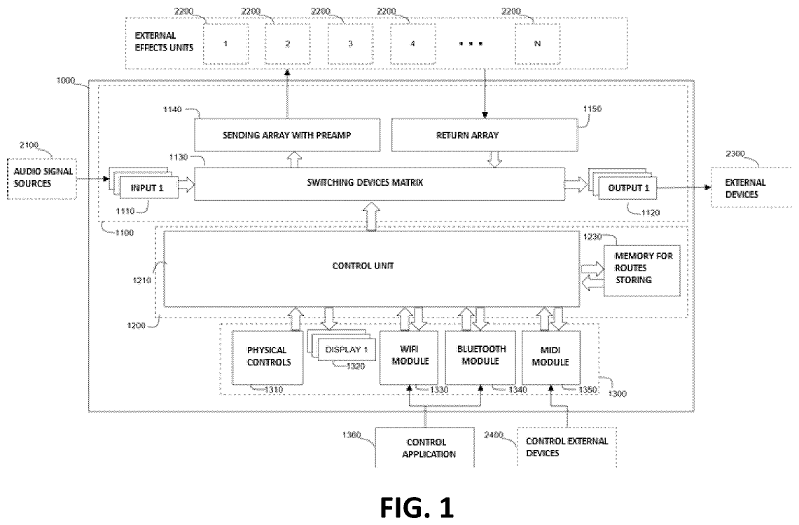

The invention refers to an electronic device controlling the route followed by one or several audio signals through two or more External Devices which modify said route to be delivered to one or several Outputs, the main elements of the invention are shown in FIG. 1, and which is generally identified with the number 1000. The device comprising an Interconnection Section 1100, a Control Section 1200 and a User Interface Section 1300, these components contain various elements and components that together achieve the purpose of the invention.

The audio signals to be controlled are generated by external devices called Audio Signal Sources identified with the number 2100, and enter to the Device 1000 through Input Interfaces 1110, which offer an external interface that can have a physical connection of the type XLR, TS, RCA or any standard that can carry an analog audio signal. Each Input Interface 1110 can have a Preamplifier controlled by the Control Unit 1210. The number of Input Interfaces 1110 and the type of physical connection thereof are defined in the implementation of the selected Device 1000.

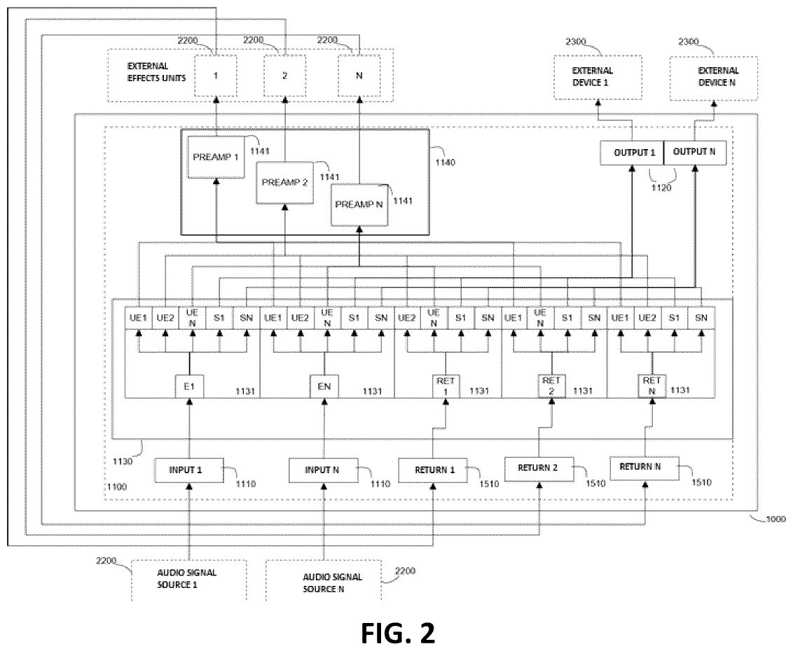

The Device 1000 sends the entered audio signals to external devices that modify the audio signal, called Effects Units and identified with the number 2200, and to work with the Device 1000 they should have an input interface and an analog output interface through which the audio signal modified by the processes of the Effects Units 2200 comes out. The inputs of each Effects Units 2200 are connected to the Device 1000 through a sending Matrix having Preamplifiers identified with the number 1140, which contains several individual Preamps shown in FIG. 2 and labeled with the number 1141. The Preamps 1141 are controlled by the Control Unit 1210. The outputs of each Effects Unit 2200 return to the Device 1000 via a Return Matrix labeled with number 1150, which contains several Return Interfaces shown in FIG. 2 and identified with the number 1151. The number of Preamps 1141 and Return Interfaces 1151 correspond to the quantity of Effects Units 2200 through which the audio signal could pass. This quantity and type of external interfaces are defined in the implementation of the selected Device 1000.

Each audio signal that has passed through the Effects Units 2200 is delivered to one or more Output Interfaces identified with the number 1120. Each Output Interface 1120 offers an external interface which can have a physical connection of the type XLR, TS, RCA or any other standard that can carry an analog audio signal. The quantity of Output Interfaces 1120 and the type of external interfaces are defined in the implementation of the selected Device 1000.

The sending and return of the audio signals is done through a Switching Devices Matrix identified with the number 1130. The Sending Matrix with Preamplifier 1140 and the Array of Returns 1150 are connected to said Switching Devices Matrix 1130. The Device Matrix 1130 contains several Switching Devices shown in FIG. 2, and are indetified with the number 1131. Through the Device Matrix 1130, it is possible to interconnect the whole Input Interfaces 1100 and the whole Return Interfaces 1151 with the whole Preamplifiers 1141 and the whole Output Interfaces 1120. Each Switching Device 1131 is able to conect any Input Interface 1100 or Return Interface 1151 to any Preamplifier 1141 or Output Interface 1120. The Switching Devices 1131 can be of any type available on the market, selected from analog, digital, mechanical, solid-state, etc., or composed of various elements as long as they have a switching speed of 200 ms or less, they can switch an input to more than one simultaneous output, and that they can be controlled by digital signals and that through this control it would be possible to specifically select to which Preamplifier 1141 or Output Interface 1120 the Input Interface 1100 or Return Interface 1151 will be connected, which is connected to said Switching Device 1131. Each Switching Device 1131 is controlled by the Control Unit 1210.

The Control Unit 1210 is a digital device executing the general control tasks of the device's operation which refer to: 1) Control of the Status of the Switching Devices Matrix 1130, 2) Storage and recovery of Statuses of the Switching Devices Matrix, hereinafter referred as Routes, in the Memory Device identified with the number 1220; 3) Control of operation modes of the Device 1000 and the components contained in the User Interface Section 1300.

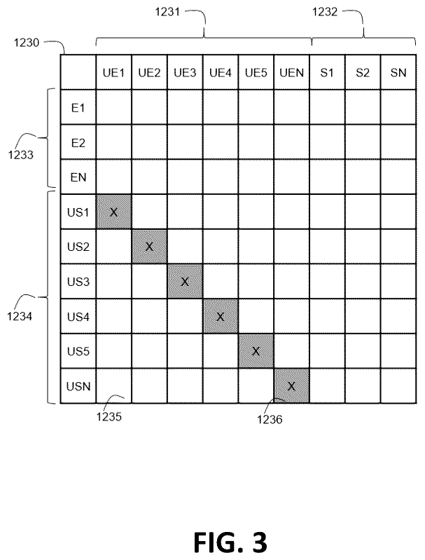

As to the task of Control of the Status of the Switching Device Matrix, this is performed by means of a Digital Logic Matrix shown in FIG. 3 and identified with the number 1250. The size of the Digital Matrix 1250 is determined as follows: 1) One rung for each Input Interface 1110 in the implementation of the Device 1000 and one rung for each Effects Unit 2200 that could be controlled in the implementation of the Device 1000; and 2) One column for each rung for each Effects Unit 2200 that could be controlled in the implementation of the Device 1000 and one column for each Output Interface 1120 in the implementation of the Device 1000. The rungs of the Digital Logic Matrix 1250 represent each of the Switching Devices 1131 within the Switching Device Matrix 1130. The columns of the Digital Logic Matrix 1250 represent each of the switching options of each of the Switching Devices 1131 within the Switching Device Matrix 1130. The values of each Cell of the Digital Logic Matrix 1250, identified with the number 1255, represent whether the input of the Switching Device 1331 corresponding to the rung of Cell 1255 is connected or not to the output of the Switching Device 1331 corresponding to the Column of Cell 1255. When Cell 1255 is worth 0 it means disconnection and when the cell is worth 1 it means connection.

The Statuses taken by the Digital Logical Matrix 1250 are determined by rules that are defined in the Specific Implementation of the Device 1000, however, there are Invalid Statuses, identified with the number 1256, which are cells of the Digital Logical Matrix 1250 which can only take the value of 0. The Invalid States 1256 are defined with the following rule: it is considered as Invalid States 1256 to all the cells 1255 that represent the connection between the Return Interface 1151 corresponding to a determined Effects Unit 2200 and the Sending to the Preamplifier 1141 that corresponds to the same Effects Unit 2200.

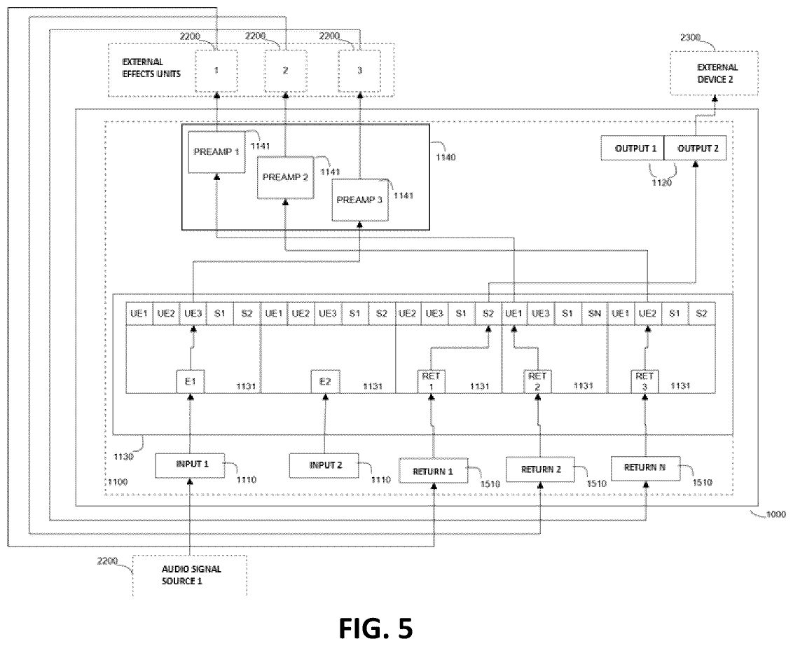

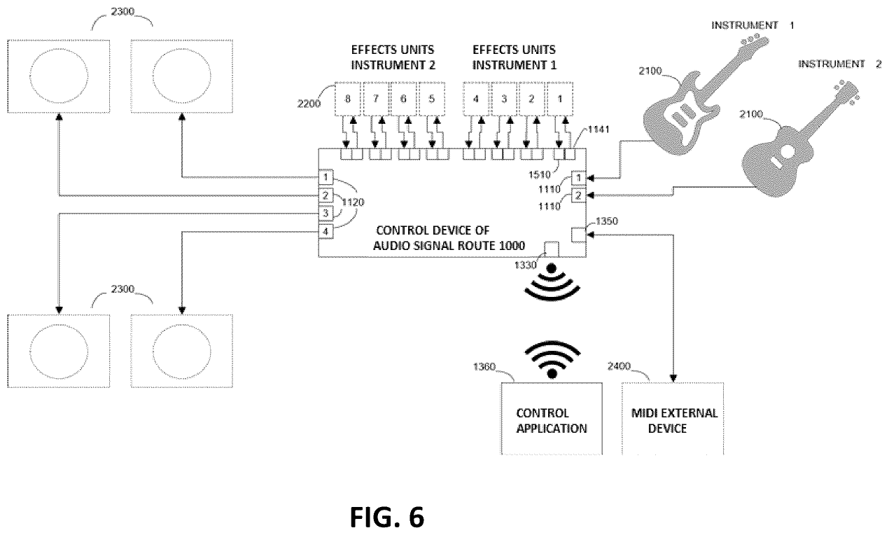

The Control Unit 1210 sends the Status of the Digital Logic Matrix 1250 to the Switching Device Matrix 1130, which makes the necessary connections and disconnections. FIG. 5 shows an example of the status of the Digital Logic Matrix 1250 corresponding to an implementation of 2 Inputs, 3 Effects Units and 2 Outputs. FIG. 6 shows a representation of the components contained in the Interconnect Section 1100 and the status of the Switching Device Matrix 1130 corresponding to the state of the Digital Logic Matrix 1250 represented in FIG. 5.

Regarding the task of Storing and retrieving the Statuses of the Switching Devices Matrix 1130, the Control Unit 1210 is configured to write in the Memory Unit 1220 some Status of the Digital Logic Matrix 1250 accompanied by an Identifier and data that is defined in the Implementation of the Device 1000 in a package called Registry. Using the Identifier, the Control Unit 1210 retrieves a specific record stored in Memory Unit 1220. Once the Record is retrieved, the Control Unit 1210 takes the corresponding data, writes it to the Digital Logic Matrix 1250 and sends it to the Switching Devices Matrix 1130.

The Control Unit 1210 is also configured to manage the devices of the User Interface section 1300, which comprises the following components: 1) Physical Controls identified with the number 1310, 2) 1 or more Displays identified with the number 1320, 3) Control modules which allow WI-FI wireless connection, identified with the number 1330, or Bluetooth, identified with the number 1340, which allows its control and operation through an Application developed specifically for the control of the device, identified with the number 1360, contained in an external device such as a Personal Computer, Smartphone or Tablet supporting these connection modes, 4) module that enables the MIDI (Musical Instrument Digital Interface) standard protocol identified with the number 1350. The inclusion, type and quantity of components 1310, 1320, 1330, 1340, 1350, and 1360 are determined by the specific Implementation of the Device 1000. These Components define the way in which the user will use the Device 1000, either by handling it directly or through External Devices, identified with the number 2400, which are compatible with said components.

FIG. 6 exemplifies an implementation of the Device 1000 in which the signal of two musical instruments 2100 is controlled through eight Effects Units 2200 and then is delivered to two pairs of amplifiers 2300, one pair for each musical instrument.

Device 1000 is configured using the Control Application 1360 which resides on a mobile device external to said Device 1000 and is connected via Wi-Fi using said module 1330 of the Device 1000. With this Control Application 1360 a set of Routes is established through which each audio signal coming from the Instruments 2100 and through the Effects Units 2200 will pass. In each Route the Instrument 2100 of origin is selected, the Effects Units 2200 through which it passes and in what order, and to which outputs 1120 is delivered, in addition of the level of the Sending Preamp 1141 corresponding to the respective Effects Unit 2200. In this exemplary implementation it is defined as a rule for the Routing configuration that an Effects Unit can receive only one audio signal regardless of its source.

Through the Control Application 1360, each Route is stored in the Memory Unit 1230 with an identifier. The following table shows the construction of Routes stored in the Memory Unit 1230 for this exemplary implementation.

TABLE 1
Routes defined in the example implementation

| | INSTRUMENT | EFFECTS | |
|---|---|---|---|
| ROUTE | (AUDIO SIGNAL | UNITS | |
| IDENTIFIER | SOURCE) | SEQUENCE | OUTPUTS |
| 1 | 1 | 2-3-6 | 1 y 2 |
| 2 | 2 | 1-5-4 | 3 y 4 |
| 3 | 1 | 1-7-5 | 1 y 2 |
| 4 | 2 | 2 | 3 y 4 |
| 5 | 1 | 8-2 | 1 y 2 |
| 6 | 2 | 5-3 | 3 y 4 |

The exemplary implementation includes an External Control Device 2400 which is compatible with the MIDI standard connected to the Device 1000 via the MIDI module 1350. The External Control Device 2400 sends instructions to Device 1000 using the MIDI protocol to retrieve the routes stored in the Memory Unit 1230 with which the Control Unit 1210 sends the statuses to the Switching Devices Matrix 1130 and to the Sending array with Preamplifier 1140 so that the corresponding internal connections are activated and the signal is sent to the Effects Units in the established order. In this exemplary implementation, it is established as a rule to activate Routes that it is possible to activate two Routes simultaneously as long as they come from different 2100 Instruments and it is not intended send the signal of 2 different Instruments 2100 to the same Effects Unit 2200.

DISCLAIMER: The implementation of the described Device 1000 is only to exemplify its operation in a specific scenario, however, the operation of the Device 1000 is not limited to it.

1. Electronic device that allows controlling the route followed by an audio signal from one or more Audio Signal Input Sources through two or more Effects Units modifying said signal, characterized in that comprising:
a) an Interconnection Section comprising mainly physical interfaces and a matrix of high-speed signal switching devices (analog or digital) with features of an audio signal that allows the interconnection of the whole Inputs with the whole Outputs;
b) a Control Section which allows activating one or more of the possible interconnection combinations, called Routes, and storing these combinations in a memory module; and
c) a User Interface Section through which the User selects which Route is activated.

2. The Electronic Device that allows controlling the route followed by an audio signal according to claim 1, further includes a preamplifier in each input connection and each sending to the Effects Unit; and each preamp is controlled by the components in the Control Section.

3. The Electronic Device that allows controlling the route followed by an audio signal according to claim 1, wherein is configured to store in the memory module the combinations of inputs, devices through which the audio signal passes, the order in which it does so and outputs that are activated, which allows them to be recovered and activated in a time period of up to 200 ms.

4. The Electronic Device that allows controlling the route followed by an audio signal according to claim 1, wherein it offers various control and operation embodiments of the device, either by manipulating it directly, or through Wireless External Devices and/or the MIDI standard protocol.
